(19) United States
(12) Patent Application Publication
(10) Pub. No.: US 2012/0040125 A1
(43) Pub. Date: Feb. 16, 2012

(54) METHOD FOR MANUFACTURING CERAMIC SUBSTRATE AND CERAMIC SUBSTRATE USING THE SAME

(75) Inventors: Myung Whun CHANG, Seoul (KR); Dae Hyeong LEE, Seoul (KR); Ki Pyo HONG, Suwon (KR)

(73) Assignee: SAMSUNG ELECTRO-MECHANICS CO., LTD.

(21) Appl. No.: 13/017,924

(22) Filed: Jan. 31, 2011

(30) Foreign Application Priority Data
Aug. 13, 2010 (KR) 10-2010-0078498

(51) Int. Cl. B32B 3/26; B05D 3/12; B05D 5/06; B05D 1/36; B05D 7/22

(52) U.S. Cl. 428/63; 427/256; 427/181

(57) ABSTRACT

A method for manufacturing a ceramic substrate, and a ceramic substrate using the same are disclosed. The method for manufacturing a ceramic substrate includes: forming a first adhesive layer on a blister formed on a substrate; filling the blister having the first adhesive layer formed thereon with a filler; and hardening the ceramic substrate. A blister formed on the ceramic substrate can be removed to make the substrate have a smooth surface, thus improving reliability.

### CROSS-REFERENCE TO RELATED APPLICATIONS

This application claims the priority of Korean Patent Application No. 10-2010-0078498 filed on Aug. 13, 2010, in the Korean Intellectual Property Office, the disclosure of which is incorporated herein by reference.

### BACKGROUND OF THE INVENTION

1. Field of the Invention

The present invention relates to a method for manufacturing a ceramic substrate and a ceramic substrate using the same, and more particularly, to a method for manufacturing a smooth ceramic substrate without a blister, and a ceramic substrate using the same.

2. Description of the Related Art

A general semiconductor testing device, including a tester, a performance board, a probe card, a chuck, and a prober, tests the electrical characteristics of chips fabricated on a wafer. A probe card of the semiconductor testing device serves to receive a signal generated by a tester via a performance board and to deliver the signal to pads of the chips in the wafer, and also delivers a signal output from the pads of the chips to the tester via the performance board.

The related art probe card includes a probe substrate formed at a central portion of the probe card and having an opening and a signal line, and a probe (or an explorer) fixing stand coupled to the opening of the probe substrate, and a probe fixed to a lower surface of the probe fixing stand.

Recently, the size of chips to be tested has been reduced, in line with the high integration and reduction in size of products, and the probe card for testing the chips is also becoming reduced in size.

In order to reduce the size of the probe card, a substrate using a ceramic is in use. A main component of the ceramic substrate is a ceramic composition containing a large amount of glass available for low temperature cofiring.

There are various methods for manufacturing a low temperature cofired ceramic (LTCC) substrate, and these methods may be classified into a shrinkage technique and a non-shrinkage technique, depending on whether or not a ceramic substrate is shrunken when fired.

In detail, a method for manufacturing a ceramic substrate by making the ceramic substrate shrunken when fired is known as the shrinkage technique. However, with the shrinkage technique, the degree of shrinkage in the ceramic substrate is not uniform, causing a dimension change in a planar direction of the substrate.

The shrinkage in the planar direction of the ceramic substrate brings about a deformation of a printed circuit pattern included in the substrate, degrading the precision of pattern positions, causing the disconnection of patterns, and the like.

Even the non-shrinkage technique, which has been proposed to prevent the shrinkage in the planar direction of the ceramic substrate when fired in the shrinkage technique, exposes a similar problem.

In a ceramic substrate manufactured according to the non-shrinkage technique, portions of ceramic green sheets constituting respective layers of the ceramic substrate are punched to form via holes, and the via holes are filled with a conductive paste to form via electrode parts, the via electrode parts serving to electrically connect inner electrodes and outer electrodes formed in and on the ceramic green sheets respectively.

However, even when the ceramic substrate is manufactured by using the non-shrinkage technique, because the ceramic green sheets constituting a laminated ceramic body, the via electrode parts, and the outer and inner electrode parts are made of different materials, voids or blisters are bound to be formed on the surface of the substrate due to the difference in the shrinkage characteristics and the difference in the coefficient of thermal expansion in the interfaces when the ceramic substrate is fired.

A blister formed on the surface of the substrate of a final product acts as an obstacle in making thin films uniform or even, resulting in a degradation of the reliability of the probe substrate.

### SUMMARY OF THE INVENTION

An aspect of the present invention provides a method for manufacturing a ceramic substrate capable of removing a blister formed on a ceramic substrate through a simple process to thus enhance the reliability of the substrate, and a ceramic substrate using the same.

According to an aspect of the present invention, there is provided a method for manufacturing a ceramic substrate, including: forming a first adhesive layer on a blister formed on a substrate; filling the blister having the first adhesive layer formed thereon with a filler; and hardening the ceramic substrate.

The method may further include: forming a second adhesive layer on the ceramic substrate after the blister has been filled with the filler.

The method may further include: after the ceramic substrate is hardened, polishing a surface of the hardened ceramic substrate to remove the second adhesive layer to planarize the substrate.

The first or second adhesive layer may include glass.

The glass may include SiO₂.

The filler may be alumina powder.

The filler may have a form of a liquefied alumina bond or alumina putty.

One or more of the first adhesive, the second adhesive, and the filler may include a coloring agent.

According to another aspect of the present invention, there is provided a ceramic substrate including: a ceramic substrate with a blister; a filling part filling the blister; and a first adhesive layer formed between the ceramic substrate and the filling part to bond the ceramic substrate and the filling part.

The ceramic substrate may further include: a second adhesive layer formed to cover the filling part formed on the ceramic substrate to bond the filling part and the ceramic substrate.

The first or second adhesive layer may include glass.

The glass may include SiO₂.

One or more of the first adhesive layer, the second adhesive layer, and the filling part may include a coloring agent.

The filling part may comprise alumina.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a flow chart illustrating the process of removing a blister from a ceramic substrate according to an exemplary embodiment of the present invention;

FIGS. 2a to 2e are views showing sequential processes of eliminating a blister formed on the ceramic substrate according to an exemplary embodiment of the present invention;

FIG. 3a is an upper sectional view showing a blister formed on the ceramic substrate; and

FIG. 3b is an upper sectional view showing a state in which the blister formed on the ceramic substrate is filled according to an exemplary embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions may be exaggerated for clarity, and the same reference numerals will be used throughout to designate the same or like components.

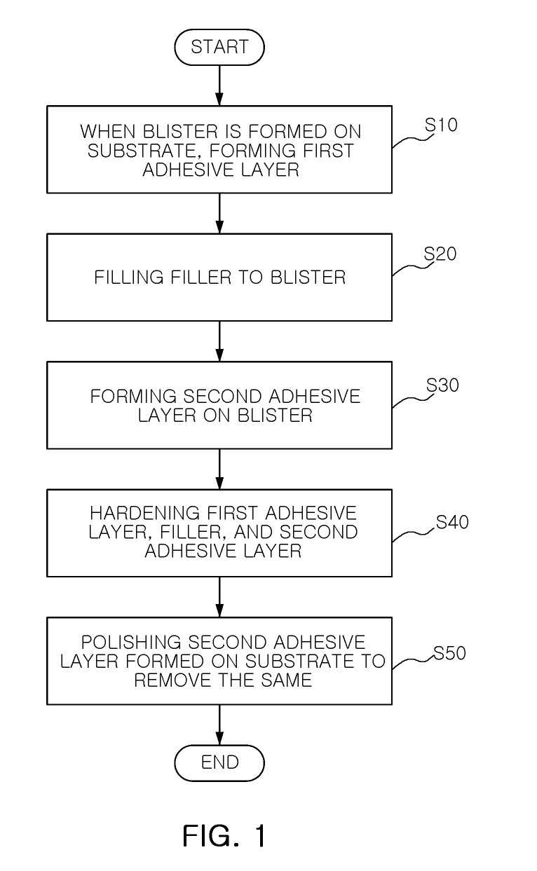

FIG. 1 is a flow chart illustrating the process of removing a blister from a ceramic substrate according to an exemplary embodiment of the present invention.

According to a method for manufacturing a ceramic substrate without a blister according to an exemplary embodiment of the present invention, a blister refers to a bubble, a gap, an opening, and the like.

The method for manufacturing a ceramic substrate without a blister according to an exemplary embodiment of the present invention includes a step (S10) of forming a first adhesive layer on a blister in order to fill the blister on the ceramic substrate having the blister. The first adhesive layer serves to bond the filler filling the blister and the ceramic substrate, preventing the filler from being detached from the substrate.

The method further includes a step (S20) of filling the blister having the first adhesive layer formed thereon with a filler. The filler is made of a ceramic having excellent acid and chemicals resistivity, and eliminates the blister of the substrate to make the thin film smooth.

Thereafter, a second adhesive layer is formed on the filler (step S30), and the ceramic substrate filled with the filler is hardened (step S40). The first and second adhesive layers, made of glass having SiO₂ as a main ingredient, serve to prevent the filler from being separated from the substrate due to the difference in shrinkage between the ceramic substrate and the filler when the filler is hardened.

After the second adhesive layer is hardened, the ceramic substrate is polished to remove the second adhesive layer (step S50).

According to the method for manufacturing a ceramic substrate without a blister according to an exemplary embodiment of the present invention, the ceramic substrate can be manufactured without a blister, improving the reliability of the substrate.

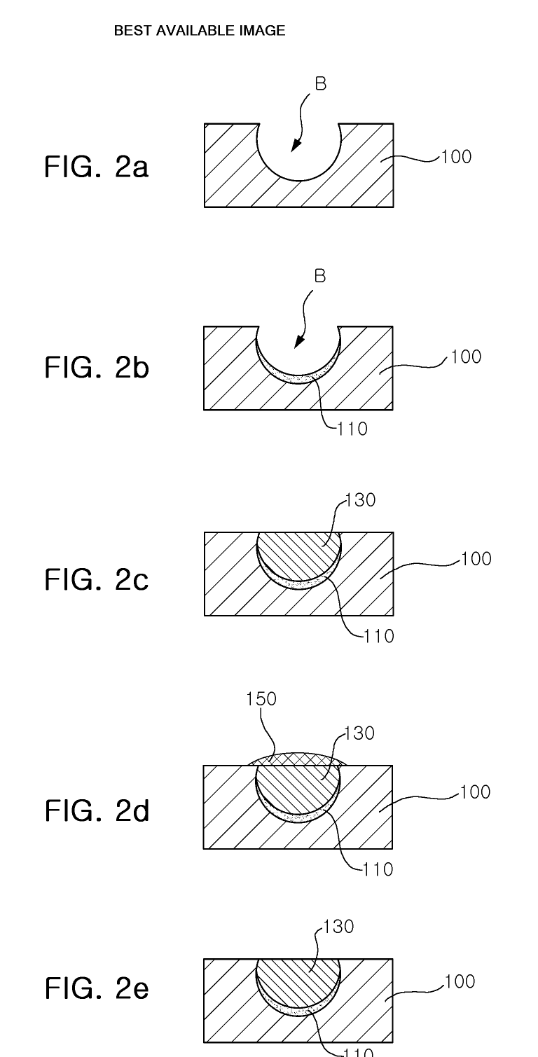

FIGS. 2a to 2e are views showing a sequential process of eliminating a blister formed on the ceramic substrate according to an exemplary embodiment of the present invention. The method for manufacturing a ceramic substrate without a blister, according to an exemplary embodiment of the present invention, will be described in detail with reference to FIGS. 2a to 2e.

FIGS. 2a and 2b show steps of forming the first adhesive layer on a blister formed on the ceramic substrate.

With reference to FIG. 2a, a blister (B) in an undesired form may be formed in the ceramic substrate 100 in manufacturing the ceramic substrate 100. The blister (B), a cavity having the form of a bubble, an opening, a gap, and the like, formed on the surface of the substrate, forms an irregular portion on a surface of the substrate to act as a factor of a defective substrate in the follow-up process of stacking and forming thin films. Also, when the blister (B) is formed on the surface of the substrate, the reliability of the substrate is degraded in forming a high density circuit.

Thus, in order to manufacture the ceramic substrate 100 without such a blister (B), the blister (B) formed on the ceramic substrate 100 is filled with a filler, or the like, or the surface of the substrate is polished to remove the blister.

According to an exemplary embodiment of the present invention, in order to eliminate the blister (B), a first adhesive layer 110 is formed on the blister (B) of the ceramic substrate.

The first adhesive layer 110 is made of an inorganic binder such as glass, but is not limited thereto. Also, a main ingredient of the glass, which is produced by using alcohol as a solvent, is SiO₂.

Because the first adhesive layer 110 is made of glass, it can improve an adhesive force between the filler filling the blister and the substrate, to prevent the filler from being detached from the blister (B).

FIG. 2c illustrates a step of filling the ceramic substrate 100, on which the first adhesive layer 110 is formed, with the filler.

A filling part 130 filled with the filler including a ceramic component is formed on the blister (B). The filler is made of ceramic having excellent chemical resistance and durability, which is similar to that of the ceramic substrate 100, so the ceramic substrate can be manufactured to have excellent chemical resistance and durability.

The filler may be alumina powder. Alternatively, the filler may be a liquefied alumina bond or alumina putty made from alumina powder.

FIG. 2d illustrates a step of forming a second adhesive layer 150 on the ceramic substrate 100 filled with the filler 130.

The second adhesive layer 150 is formed to cover the filling part 130 filled with the filler.

The second adhesive layer 150 may be made of an inorganic binder such as glass, but is not limited thereto. A main ingredient of the glass, produced by using alcohol as a solvent, is SiO₂.

Because the second adhesive layer 150 is made of glass, it can prevent the filling part from being separated from the substrate due to the difference in shrinkage between the filler and the ceramic substrate 100 when the filler is hardened.

FIG. 2e shows a step of polishing the surface of the ceramic substrate to remove the second adhesive layer 150 to make the substrate smooth.

After the ceramic substrate 100 is hardened, the surface of the substrate is bound to have irregular portions due to presence of the second adhesive layer. The irregular portions may cause a defective substrate in a follow-up step of stacking the substrate or forming a thin film, so the surface of the substrate is required to be planarized.

Thus, the surface of the substrate is polarized through polishing, or the like, but the present invention is not limited thereto.

Accordingly, because the surface of the ceramic substrate 100, which has undergone the polarization process, is smooth, a defect otherwise caused due to an irregular portion of the surface of the substrate can be reduced.

One or more of the first adhesive, the second adhesive, and the filler may include a coloring agent. Because the coloring agent is included, the surface having the blister-filled portion can appear the same as the surface without such a blister-filled portion, as well as having the smooth surface.

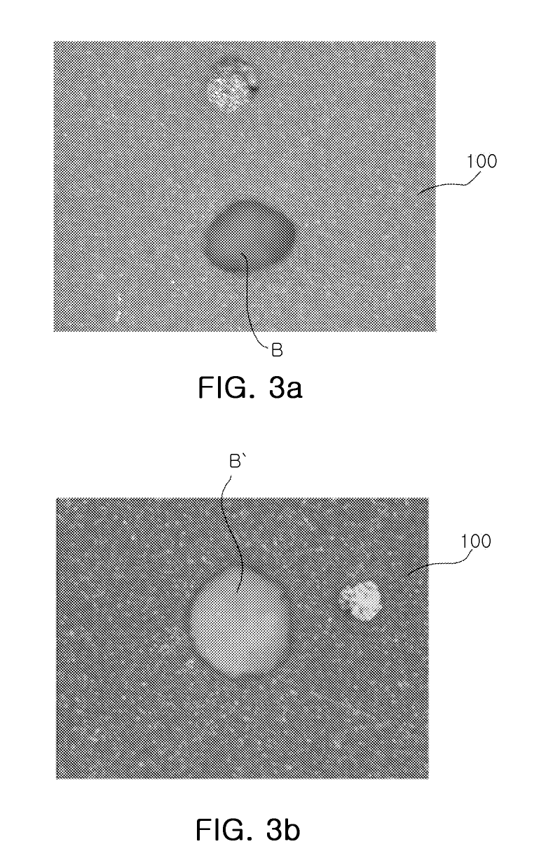

FIG. 3a is an upper sectional view showing a blister formed on the ceramic substrate. The blister (B) shown in black is formed in the surface of the substrate, making the surface of the substrate irregular and causing a defective substrate.

However, as shown in FIG. 3b, the blister (B) may be filled with a filler to form a blister (B′).

A filling part filled with the filler for filling the blister is formed on the ceramic substrate 100 with a blister.

A first adhesive layer may be formed between the filling part and the substrate in order to bond the filling part and the ceramic substrate.

A second adhesive layer may be provided on the surface of the filling part in order to prevent the filling part from being discharged in a hardening process, thus strengthening an adhesive force between the ceramic substrate 100 and the filling part.

The second adhesive layer may be removed through polishing, or the like, to provide the ceramic substrate 100 having a smooth surface.

In this manner, the ceramic substrate 100 has the blister (B′) filled with the filler. In this case, because the blister (B′) is filled with the filler and planarized through the polishing process, or the like, the ceramic substrate 100 has a physically smooth surface.

In addition, because the filler includes a coloring agent, it can have the same color as that of the other portions of the ceramic substrate 100 in appearance.

The blister (B), remaining unfilled on the surface of the ceramic substrate 100, as shown in FIG. 3a, forms an irregular portion on the surface of the ceramic substrate 100, which is, thus, troublesome in forming a thin film in a thin film forming process, and the like, but when the blister (B) is filled with a filler as shown in FIG. 3b, because the surface of the ceramic substrate becomes smooth, a uniform thin film can be formed in performing the thin film forming process, and the like, improving the reliability of the substrate.

As set forth above, according to exemplary embodiments of the invention, a blister formed on a ceramic substrate can be removed through a simple process, thus improving the reliability of the ceramic substrate.

While the present invention has been shown and described in connection with the exemplary embodiments, it will be apparent to those skilled in the art that modifications and variations can be made without departing from the spirit and scope of the invention as defined by the appended claims.

What is claimed is:

1. A method for manufacturing a ceramic substrate, the method comprising:
forming a first adhesive layer on a blister formed on a substrate;
filling the blister having the first adhesive layer formed thereon with a filler; and
hardening the ceramic substrate.

2. The method of claim 1, further comprising:
forming a second adhesive layer on the ceramic substrate after the blister has been filled with the filler.

3. The method of claim 2, further comprising:
after the ceramic substrate is hardened, polishing a surface of the hardened ceramic substrate to remove the second adhesive layer to planarize the substrate.

4. The method of claim 2, wherein the first or second adhesive layer comprises glass.

5. The method of claim 4, wherein the glass comprises SiO₂.

6. The method of claim 1, wherein the filler is alumina powder.

7. The method of claim 1, wherein the filler has a form of a liquefied alumina bond or alumina putty.

8. The method of claim 4, wherein one or more of the first adhesive, the second adhesive, and the filler comprises a coloring agent.

9. A ceramic substrate comprising:
a ceramic substrate with a blister;
a filling part filling the blister; and
a first adhesive layer formed between the ceramic substrate and the filling part to bond the ceramic substrate and the filling part.

10. The substrate of claim 9, further comprising:
a second adhesive layer formed to cover the filling part formed on the ceramic substrate to bond the filling part and the ceramic substrate.

11. The substrate of claim 10, wherein the first or second adhesive layer comprises glass.

12. The substrate of claim 11, wherein the glass comprises SiO₂.

13. The substrate of claim 10, wherein one or more of the first adhesive layer, the second adhesive layer, and the filling part comprises a coloring agent.

14. The substrate of claim 9, wherein the filling part comprises alumina.
